(19) United States
(12) Patent Application Publication
(10) Pub. No.: US 2013/0149909 A1
(43) Pub. Date: Jun. 13, 2013

(54) CONNECTOR MODULE WITH A CONNECTING DEVICE

(71) Applicants: Kou-Ching LEE, New Taipei City (TW); Jian-Li Guan, New Taipei City (TW); Ya-Ping Liang, New Taipei City (TW); Yao-Te Wang, New Taipei City (TW)

(72) Inventors: Kou-Ching LEE, New Taipei City (TW); Jian-Li Guan, New Taipei City (TW); Ya-Ping Liang, New Taipei City (TW); Yao-Te Wang, New Taipei City (TW)

(73) Assignee: ADVANCED-CONNECTEK INC., New Taipei City (TW)

(21) Appl. No.: 13/484,122

(22) Filed: May 30, 2012

(30) Foreign Application Priority Data
Dec. 9, 2011 (CN) 201120509767.9

(51) Int. Cl. H01R 33/00

(52) U.S. Cl. 439/660

(57) ABSTRACT

A connector includes a receptacle and terminal modules each inserted into the receptacle and having a base and a plurality of terminals securely extended through the base. A block is formed on a side of the base and a cutout is defined on the side of the base to structurally correspond to the block so that two adjacent bases are connected together.

### CROSS-REFERENCE TO RELATED APPLICATION

This application claims priority from application No. 201120509767.9, filed on Dec. 09, 2011 in the State Intellectual Property Office of the People's Republic of China.

### FIELD OF THE INVENTION

The invention relates to a connector, and more particularly to a connector module having a connecting device formed on a side face of the connector module to strengthen the integrity of the connector module both in manufacture and assembly processes.

### BACKGROUND OF THE INVENTION

Due to the increasing demand for electronic devices to be compact and durable, manufacturers all try very hard to meet the requirements. Besides, manufacturers simultaneously improve the function and stability of the electronic devices while trying to minimize the sizes thereof.

As well known in the art that the connector is aimed to be responsible for electrical signal transmission between two electronic devices so that the function and effectiveness of the connector greatly affect the electronic system's overall performance

Currently, as well known in the art, a connector is composed of a receptacle and multiple terminal modules inserted into the receptacle and respectively having a base and a plurality of terminals firmly extended through the corresponding base. During manufacture, most of the bases are made by insert molding. Thereafter, terminals are extended through the bases for mating with the receptacle. By way of this manufacture process, each and every one of the bases is isolated from one another such that while the bases with a plurality of terminals firmly attached thereto are to be mated with the receptacle, loose connection among bases is a common problem, which may somehow lead to more serious problems in the future. In addition to that problem, incorrect connection with the receptacle will easily lead to faulty signal transmission or even worse, the signal will not be successfully transmitted.

### SUMMARY OF THE INVENTION

The primary objective of the present invention is to provide an improved connector having a connecting device provided on a side face of the base for connection with an adjacent base so as to form an integral assembly to obviate errors during assembly.

Another objective of the present invention is to provide an improved connector having position holes alternatively defined in a bottom face of the base so as to have a distance of 0.075 mm offset to an adjacent positioning hole to prevent influences from the adjacent terminals.

In order to accomplish the aforementioned objectives, the connector constructed in accordance with the present invention includes a receptacle and multiple terminal modules securely mated with the receptacle and each having a base and terminals securely extended through the base. Each base has a connecting device formed on a side face thereof and having at least a block and a cutout structurally corresponding to that of the block such that two adjacent bases are able to mate with one another with the block inserted into the cutout.

### BRIEF DESCRIPTION OF THE DRAWINGS

FIG. 1 is a perspective view showing the connector constructed in accordance with the present invention;

FIG. 2 is an exploded perspective view of the connector in FIG. 1;

FIG. 3 is an exploded perspective view of the connector from an angle different from that of FIG. 2; and

FIG. 4 is a plan view showing the bottom side of the receptacle of the connector of the present invention.

### DETAILED DESCRIPTION OF THE INVENTION

In order to describe details of the preferred embodiment of the present invention, description of the structure, and the application as well as the steps are made with reference to the accompanying drawings. It is learned that after the description, any variation, modification or the like to the structure and the steps of the embodiments of the preferred embodiment of the present invention is easily made available to any person skilled in the art. Thus, the following description is only for illustrative purpose only and does not, in any way, try to limit the scope of the present invention.

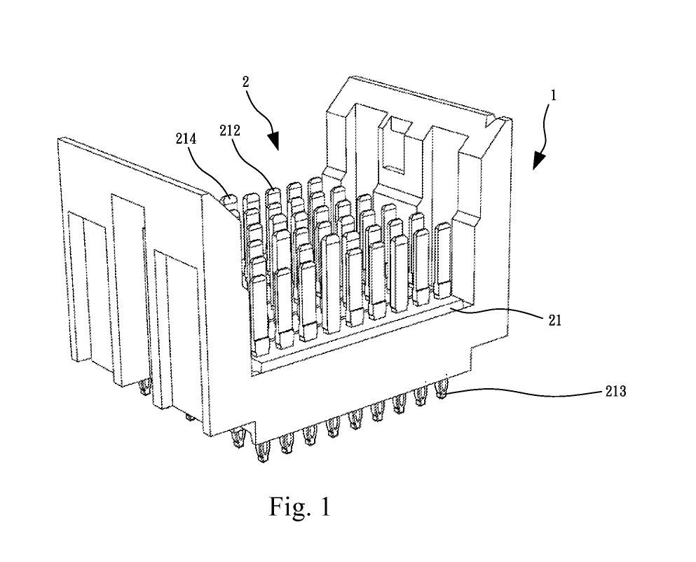

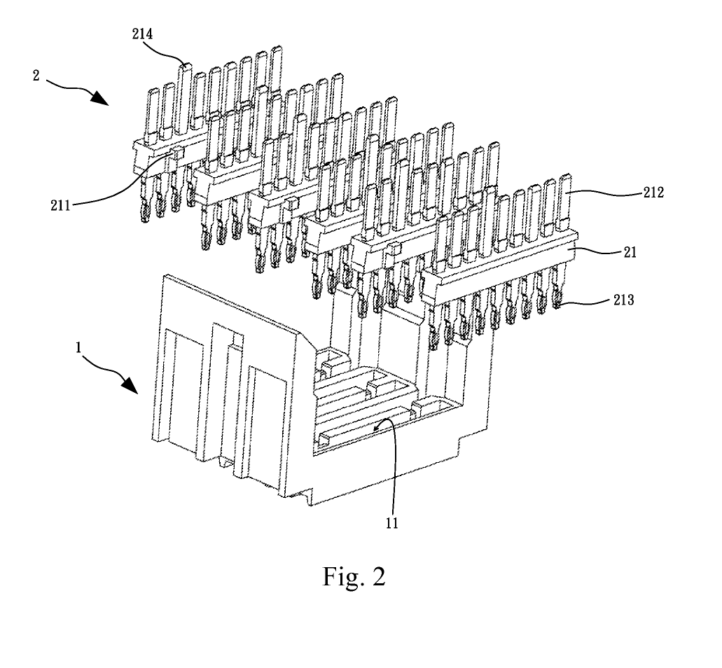

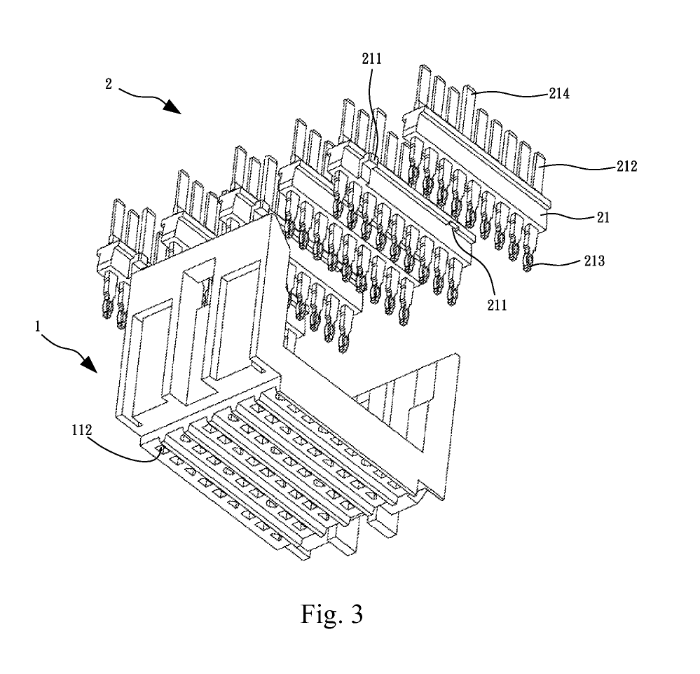

With reference to FIGS. 1, 2 and 3 of the preferred embodiment of the present invention, it is noted that the connector so constructed is composed of a receptacle 1 and multiple terminal modules 2 to be mated with the receptacle 1. The receptacle 1 has multiple receiving compartments 11 defined therein and positioning holes 12 defined in a bottom face thereof and respectively communicating with a corresponding one of the receiving holes 11.

Each of the terminal modules 2 is composed of a base 21 and multiple terminals 212 securely extending through the base 21. It is to be noted that each of the base 21 is provided with a connecting device 211 formed on a side face thereof. The connecting device 211 comprises a boss and a cutout structurally corresponding to the boss such that two adjacent terminal modules 2 are able to connect to one another by inserting the boss into the corresponding cutout. After the boss is inserted into the corresponding cutout and every two adjacent terminal modules 2 are connected, the terminal modules 2 as a whole can be easily inserted into the receiving compartments 11. Furthermore, because every two adjacent terminal modules 2 are connected together, problems such as loose connection, faulty mating relationship with the receptacle 1 are obviated. As described earlier, terminals 212 with length of 3.79 mm are securely extended through the corresponding base 21 and each terminal 212 has a connection end 213 extending toward and being positioned in the positioning holes 12 of the receptacle 1 for further connection with other electronic devices (not shown). There is a longest terminal 214 among the terminals 212 and has a length of 4.79 mm.

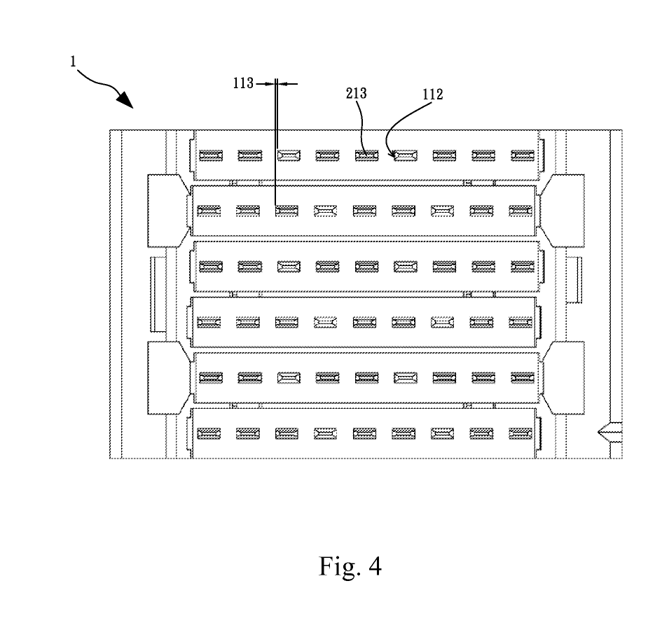

With reference to FIG. 4, it is noted that each of the matrix positioning holes 112 is alternatively defined with a distance of 0.075 mm relative to one another in the same column, as shown in the drawing, to avoid interference from adjacent terminals 212.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. In a connector having a receptacle and terminal modules each inserted into the receptacle and having a base and a plurality of terminals securely extended through the base, wherein the improvements comprise:
a block formed on a side of the base; and
a cutout defined on the side of the base to structurally correspond to the block so that two adjacent bases are connected together.

2. The connector as claimed in claim 1, wherein the receptacle has a matrix of positioning holes respectively having a distance of 0.075 mm relative to adjacent ones of the positioning holes in the same column

3. The connector as claimed in claim 1, wherein each of the terminals has a length of 3.79 mm.

4. The connector as claimed in claim 2, wherein each of the terminals has a length of 3.79 mm.

5. The connector as claimed in claim 4, wherein a terminal having a length of 4.79 mm is provided in the terminals.

6. The connector as claimed in claim 1, wherein the receptacle has a matrix of positioning holes respectively and alternatively defined relative to adjacent ones of the positioning holes in the same column.

7. The connector as claimed in claim 3, wherein the receptacle has a matrix of positioning holes respectively and alternatively defined relative to adjacent ones of the positioning holes in the same column.
